(19) United States
(12) Patent Application Publication
(10) Pub. No.: US 2005/0158530 A1
(43) Pub. Date: Jul. 21, 2005

(54) Composite material for light-, gas- and liquid-tight heat-sealing packagings

(76) Inventors: Werner Trautwein, Geilenkirchen (DE); MIchael Wolters, Heinsberg (DE); Johannes Linden, Aachen (DE)

Correspondence Address: THE WEBB LAW FIRM, P.C., 700 KOPPERS BUILDING, 436 SEVENTH AVENUE, PITTSBURGH, PA, 15219, US

(21) Appl. No.: 10/501,056

(22) PCT Filed: Jan. 17, 2003
(86) PCT No.: PCT/EP03/00429

(30) Foreign Application Priority Data
Jan. 18, 2002 (DE) 102 02 072.8

(51) Int. Cl. B32B 15/08; B32B 15/12; B32B 15/20

(52) U.S. Cl. 428/219; 428/458; 428/461; 428/464

(57) ABSTRACT

Shown and described is a composite material made of paper or cardboard as a base material with a plastic coating, in particular for light-, gas- and liquid-tight heat-sealable packages, whereby the plastic coating in each case has outer sealing layers and a barrier layer of metal is present between the base material layer and a sealing layer and a method for its production. According to the invention, a composite material should be provided, the base material layer of which is protected in such a way that a package produced therefrom can be sterilised with a product contained therein in an autoclave or such like, wherein the composite material should be produced simply and cost-effectively. This is achieved by the fact that a further barrier layer is provided on the other side of the base material layer.

The invention relates to a composite material made of paper or cardboard as a base material with a plastic coating, in particular for light-, gas- and liquid-tight heat-sealable packages, whereby the plastic coating in each case has outer sealing layers and a barrier layer of metal is present between the base material layer and a sealing layer.

Heat-sealable composite materials for the production of packages, in particular beverage packages, are known in the most varied designs. Generally, paper or cardboard serve as the base material; a lamination consisting of different layers ensures the tightness required for the particular intended use and thus the shelf life of the particular filled product. The outer sealing layers consist of a suitable thermoplastic polymer.

Numerous products to be filled, such as milk and juice for example, retain their quality under aseptic conditions only if they are also adequately protected against light, aromas and oxygen. To achieve this, a composite of cardboard coated with polyethylene is preferably used, whereby a layer of aluminium foil as a gas and aroma barrier on the inside (relative to the subsequent package) is laminated with the sealing layer onto the cardboard base material.

Such packages have been tried and tested in practice for holding perishable goods, such as for example H-milk and fruit juices. The packaged product has already been sterilised by suitable steps before the aseptic filling.

The composite structure existing according to the prior art, however, has only one barrier layer made of material impermeable to water and water vapour protecting the cardboard. Normally, this layer is arranged on the product side and protects the base material against moisture from the product. The polymer layer lying on the outside on the base material is used solely for sealability, printability and as protection against “normal” environmental influences.

For this reason, it is not possible to fill such products in a first step—in the same way as preserves—and to sterilise the product subsequently by heating in an autoclave. The autoclave water (when the barrier layer is arranged on the inside) or the water of the filled product (when the barrier layer is arranged on the outside) penetrates through the less well protected side of the cardboard composite during the autoclave process into the cardboard and thus impairs the strength/stiffness of the composite material, i.e. the package.

In order to minimise this problem, use has to be made of thick and expensive polymer layers, paint and lacquer coats, which guarantee a certain minimal water barrier. A relatively thick and chemically specially treated cardboard has to be used, which is respectively expensive.

Despite the increased outlay, the resistance capacity of such cardboard composites in the autoclave process is very limited, in particular in respect of the permitted maximum sterilisation temperature. The effect of this is that the sterilisation times have to be relatively long in order to guarantee an adequate germ destruction rate. Long autoclave cycle times, however, reduce the autoclave capacity and increase costs. Furthermore, long sterilisation times lead to a lower quality, i.e. spoil the taste, in the case of many products/foodstuffs to be packaged.

The lower resistance of the known composite material during the autoclaving process means in some cases that the water vapour/gas mixture is shifted in terms of concentration composition towards a “drier” mixture during the autoclaving process and particularly towards the end of the process. Due to the poorer heat transport, a further undesired lengthening of the autoclaving process is thus obtained.

Proceeding from this, the problem underlying the invention is to make available a composite material of the type mentioned at the outset and described in greater detail above, with which the base material layer is protected in such a way that a package produced therefrom can be sterilised with the product contained therein in an autoclave or suchlike. It is further desirable for the composite material to be able to be produced simply and cost-effectively.

This problem is solved by the fact that a further barrier layer is provided on the other side of the base material layer.

The barrier layers of metal applied on both sides of the cardboard protect the cardboard much more effectively and thus endow it with a particularly great mechanical and thermal resistance. A package produced from the composite material according to the invention can thus be sterilised without problem in an autoclave even at higher sterilisation temperatures.

This also enables higher sterilisation temperatures in the autoclave. This results in a shortening of the sterilisation time, an improvement in the taste, and an increase in the quality of the packaged product. Due to the improved protection of the cardboard, thinner and less special types of cardboard can be used.

The barrier layers of metal applied on both sides of the cardboard are ‘absolute’ barrier layers and, moreover, also have the advantage that the holes and defects on and in a barrier layer occasionally occurring in the processing operation, in particular during creasing and folding, and during transport etc., are not able to have such an unfavourable effect on the shelf life of the packaged product due to the intact second layer lying in front or to the rear thereof. The doubled metal layer thus leads to increased assurance of product quality in respect of, for example, the shelf life.

According to a further teaching of the invention, at least one connecting layer is arranged between the base material layer and the barrier layer in each case. Such a layer also designated as a bonding layer provides for better contact between the base material and the barrier layers.

A further development of the invention makes provision such that at least one further connecting layer is arranged in each case between the barrier layer and the outer sealing layer. The adhesion between the barrier layer and in the respective outer sealing layer is also improved by this measure.

In a further development of the invention, the oxygen barrier layer is made of Al-foil. A bonding agent based on a polymer or an adhesive can be used as the connecting layer.

The sealing layer consists, according to a further teaching of the invention, of a thermoplastic polymer, whereby the thermoplastic polymer can be polypropylene (PP), polyethylene terephthalate (PET), polyethylene (PE), of liquid crystalline polymers (LCP), ethylene/vinyl alcohol (EVOH) or polyamide (PA). Within the scope of the invention, however, it is also possible to form the thermoplastic polymer as a compound of the aforementioned polymers.

In a further development of the invention, the outer sealing layers have a layer thickness of 10 to 40 g/m². The outer (relative to the subsequent composite package) sealing layer preferably has a layer thickness of 10 to 20 g/m² and the inner (relative to the subsequent package) sealing layer a layer thickness of 20 to 3.5 g/m².

According to another preferred development of the invention, an aluminium foil with a layer thickness of 5 to 10 μm, preferably 6 to 8 μm, is provided as the barrier layer.

A further development of the invention makes provision such that the connecting layer (bonding layer) has a layer thickness of 4 to 20 g/m², preferably 5 to 10 g/m². It is particularly expedient here for the connecting layer present between the base material layer and the barrier layers to be thicker than the connecting layer between the barrier layers and the outer sealing layers.

In a further development of the invention, the composite material according to the invention can be produced in a single work cycle in the co-extrusion process.

The invention will be explained below in greater detail with the aid of a drawing representing solely preferred examples of embodiment. The drawing shows the following:

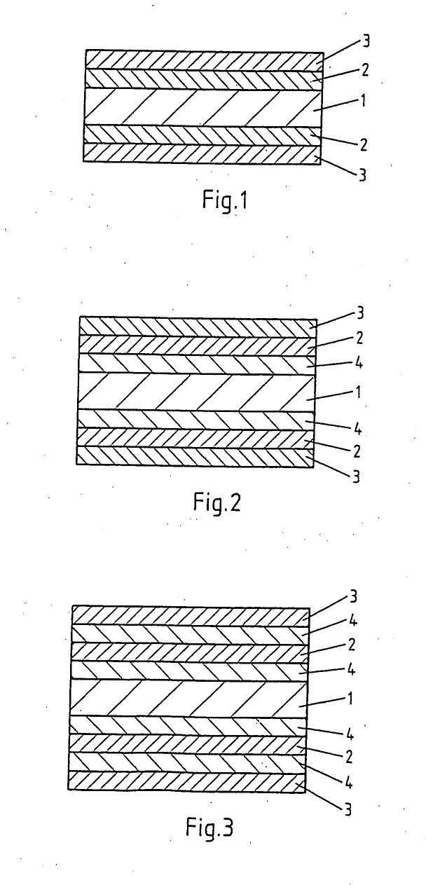

FIG. 1 a first example of embodiment of a composite material according to the invention,

FIG. 2 a second example of embodiment of a composite material according to the invention,

FIG. 3 a further example of embodiment of a composite material according to the invention.

In the figures, examples of composite materials according to the invention are represented schematically in cross-section and not true to scale.

FIG. 1 shows, as the base material, a cardboard layer 1, which is surrounded by two barrier layers 2 to protect the cardboard against the surface attack by water during the autoclaving process. Al-foil or layers of SiOx, LCP (liquid crystalline polymers), etc. can be used as barrier layers 2.

On the outside, the composite is provided with two sealing layers 3, which are made of a thermoplastic polymer, whereby the thermoplastic polymer can be polypropylene (PP), polyethylene terephthalate (PET), polyethylene (PE), of liquid crystalline polymers (LCP), ethylene/vinyl alcohol (EVOH) or polyamide (PA). Sealing layers 3 enable a fusion of the composite and can also be constituted by several polymer layers or a compound thereof.

FIG. 2 shows a further example of embodiment of a composite material according to the invention, with which an improved composite adhesion is enabled by additional connecting layers 4 between cardboard layer 1 and barrier layers 2. The connecting layers 4 consist of a bonding agent on a polymer or adhesive base.

Finally, FIG. 3 represents a third example of embodiment, with which two further connecting layers 4 are provided between barrier layers 2 and outer sealing layers 3.

1-25. (canceled)

26. A composite material comprised of one of paper and cardboard as a base material layer with a plastic coating for use in light-tight, gas-tight and liquid-tight heat-sealable packages, wherein the plastic coating includes:
a plurality of outer sealing layers;
a first barrier layer of metal situated between the base material layer and at least one of the plurality of sealing layers, wherein the first barrier layer is situated on one side of the base material layer; and
a second barrier layer situated on the other side of the base material layer.

27. The composite material according to claim 26, wherein a first connecting layer is arranged between the base material layer and one of the first barrier layer and the second barrier layer.

28. The composite material according to claim 27, wherein a second connecting layer is arranged between the second barrier layer and at least one of the plurality of outer sealing layers.

29. The composite material according to claim 26, wherein the first and second barrier layers are comprised of Al-foil.

30. The composite material according to claim 26, wherein a bonding agent is comprised of a polymer, wherein the bonding agent is used as the connecting layer.

31. The composite material according to claim 26, wherein a bonding agent is comprised of an adhesive, wherein the bonding agent is used as the connecting layer.

32. The composite material according to claim 26, wherein a thermoplastic polymer is used as at least one of the plurality of the sealing layers.

33. The composite material according to claim 32, wherein the thermoplastic polymer is polypropylene.

34. The composite material according to claim 32, wherein the thermoplastic polymer is polyethylene terephthalate.

35. The composite material according to claim 32, wherein the thermoplastic polymer is polyetheylene.

36. The composite material according to claim 32, wherein the thermoplastic polymer is comprised of liquid crystalline polymers.

37. The composite material according to claim 32, wherein the thermoplastic polymer is ethylene/vinyl alcohol.

38. The composite material according to claim 32, wherein the thermoplastic polymer is polyamide.

39. The composite material according to claim 32, wherein the thermoplastic polymer is a compound comprised of one of polypropylene, polyethylene terephthalate, polyethylene, ethylene/vinyl alcohol, and polyamide.

40. The composite material according to claim 26, wherein at least one of the plurality of sealing layers has a layer thickness of 10 to 40 g/m².

41. The composite material according to claim 40, wherein at least one of the plurality of outer sealing layers has a layer thickness of 10 to 20 g/m² relative to a subsequent composite package.

42. The composite material according to claim 40, wherein an inner sealing layer has a layer thickness of 20 to 35 g/m² relative to a subsequent composite package.

43. The composite material according to claim 28, wherein one of the first barrier layer and the second barrier layer are an Al-foil with a layer thickness of 5 to 10 μm.

44. The composite material according to claim 43, wherein the Al-foil has a layer thickness of 6 to 8 μm.

45. The composite material according to claim 28, wherein one of the first connecting layer and the second connecting layer has a layer thickness of 4 to 20 g/m².

46. The composite material according to claim 44, wherein one of the first connecting layer and the second connecting layer has a layer thickness of 5 to 10 g/m².

47. The composite material according to claim 28, wherein the first connecting layer between the base material layer and the first barrier layer is thicker than the second connecting layer between the second barrier layer and the at least one of the plurality of outer sealing layers.
